(19) United States
(12) Patent Application Publication
(10) Pub. No.: US 2026/0267889 A1
(43) Pub. Date: Sep. 10, 2026

(54) Vector Search Using Adapted Embeddings

(71) Applicant: Oracle International Corporation, Redwood City, CA (US)

(72) Inventors: Michael Louis Wick, Lexington, MA (US); Jeffrey H. Alexander, Arlington, MA (US)

(21) Appl. No.: 19/071,628

(22) Filed: Mar. 5, 2025

(51) Int. Cl. G06F 16/334; G06F 16/3332

(52) U.S. Cl. CPC G06F 16/3347; G06F 16/3334; G06F 16/3346

(57) ABSTRACT

Methods, techniques and systems for providing improved vector search using adapted embedding are disclosed. Vector representations of documents may be stored for searching, the vectors generated according to a pre-trained embedding model. A de-embedding head of the model may be repurposed as an inverse embedding model for determining similarity during search, the inverse embedding model trained on the generated vectors and the resulting model weights used to precompute an inverse hessian matrix. The precomputed matrix may then be used to identify vectors according to search query predicates.

### BACKGROUND

### Field of the Disclosure

This disclosure relates generally to computer hardware and software, and more particularly to systems and methods for implementing searches of vector data stores.

### Description of the Related Art

Vector stores are a popular search paradigm in which documents and queries are converted to embedding vectors by running an embedding model to embed terms in documents and queries. Search results are ranked by measuring the dot product or cosine similarity between the query and document vectors. To achieve good performance, the pre-trained embedding model may be fine-tuned on labeled search relevance data This approach has several problems. For example, availability of labeled data for fine-tuning may be a problem, particularly in regard to its relevance to data in the vector store. In addition, fine-tuning may lead to a problem known as catastrophic forgetting, a phenomenon that occurs when a trained model forgets previously learned information after further training.

### SUMMARY

Methods, techniques and systems for providing improved vector-store search using self-supervision to adapt embedding vectors to statistics of the data in the vector store are disclosed. These improvements do not use fine-tuning for the adaption and so do not require labeled search relevance data and are not susceptible to the catastrophic forgetting of other approaches. Vector representations of documents may be stored for searching, the vectors generated according to a pre-trained embedding model. A de-embedding head of the model may be repurposed as an inverse embedding model for determining similarity during search, the inverse embedding model trained on the generated vectors and the resulting model weights used to precompute an inverse hessian matrix. The precomputed matrix may then be used to identify vectors according to search query predicates.

### BRIEF DESCRIPTION OF THE DRAWINGS

FIG. 1 is a block diagram illustrating a system for providing improved vector search using adapted embedding, according to at least one embodiment.

FIG. 2 is a block diagram illustrating a system for training an embedding model, according to at least one embodiment.

FIG. 3 is a block diagram illustrating storing vectors in a system that provides improved vector search using adapted embedding, according to at least one embodiment.

FIG. 4A is a block diagram illustrating querying vectors in a system that provides improved vector search using adapted embedding, according to at least one embodiment.

FIG. 4B is a technique for computing adapted embeddings with self-supervision in a system that provides improved vector search using adapted embedding, according to at least one embodiment.

FIG. 5 is a timing diagram of a system for providing improved vector search using adapted embedding, according to at least one embodiment.

FIG. 6 is a flow diagram illustrating querying vectors in a system that provides improved vector search using adapted embedding, according to at least one embodiment.

FIG. 7 is a flow diagram illustrating precomputing search data for querying vectors in a system that provides improved vector search using adapted embedding, according to at least one embodiment.

FIG. 8 is a flow diagram illustrating training an inverse embedding model in a system that provides improved vector search using adapted embedding, according to at least one embodiment.

FIG. 9 is a block diagram illustrating one embodiment of a computing system that is configured to implement privacy-preserving domain integration, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112 (f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Vector stores are a popular search paradigm in which documents and queries are converted to embedding vectors by running an embedding model to embed terms in documents and queries. Search results are ranked by measuring the dot product or cosine similarity between the query and document vectors. To achieve good performance, the pre-trained embedding model may be fine-tuned on labeled search relevance data. This approach has several problems. For example, availability of labeled data for fine-tuning may be a problem, particularly in regard to its relevance to data in the vector store. In addition, fine-tuning may lead to a problem known as catastrophic forgetting, a phenomenon that occurs when a trained model forgets previously learned information after further training.

Methods, techniques and systems for providing improved vector-store search using self-supervision to adapt embedding vectors to statistics of the data in the vector store are disclosed. These improvements do not use fine-tuning for the adaption and so do not require labeled search relevance data and are not susceptible to the catastrophic forgetting of other approaches. Vector representations of documents may be stored for searching, the vectors generated according to a pre-trained embedding model. A de-embedding head of the model may be repurposed as an inverse embedding model for determining similarity during search, the inverse embedding model trained on the generated vectors and the resulting model weights used to precompute an inverse hessian matrix. The precomputed matrix may then be used to identify vectors according to search query predicates.

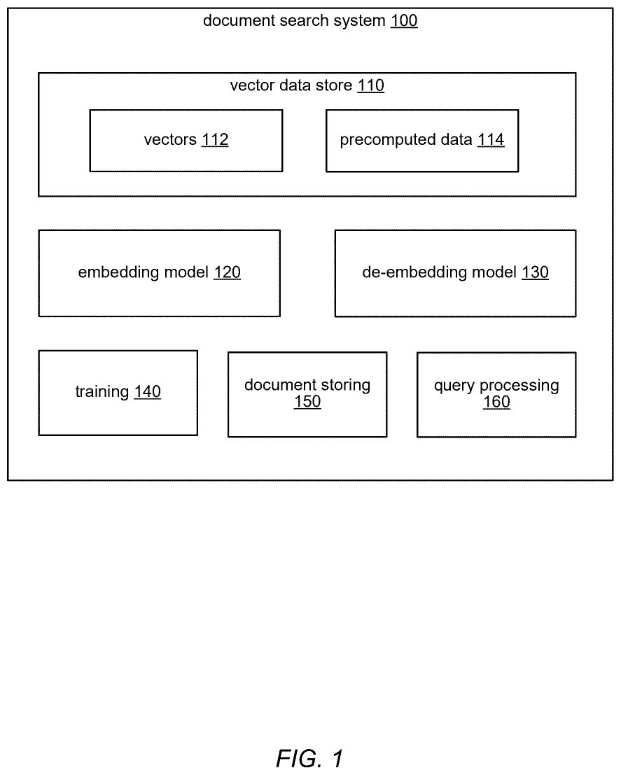

FIG. 1 is a block diagram illustrating a system for providing improved vector search using adapted embedding, according to at least one embodiment. A document search system 100 may store information in the form of data vectors 112 representing documents to be searched by clients using search queries, in various embodiments. Document search system 100 may employ a vector data store 110 to store vectors 112 and may additionally store precomputed data 114 used to accelerate similarity determinations performed during search operations.

In at least one embodiment, stored vectors 112 may be input to the document search system for storage in a document form. For example, documents may be submitted to the document search system 100 in a textual form, or in an audio-visual form such as using audio recordings, still or video images, in various embodiments. It should be understood that these examples are not intended to be limiting and any number of document formats may be envisioned for input.

To convert input documents for internal storage, in at least one embodiment the document search system may include and embedding model 120 and corresponding de-embedding, or inverse embedding, model 130. For example, in the case of input documents in a textual format, a large language model (LLM) may be used to convert documents to embedding vectors for subsequent storage. Pretrained models such as BERT or colBERT may be used for embedding model 120, in various embodiments. To facilitate training, embedding model 120 may include a de-embedding head to convert embedding vectors back into document form for purposes of training feedback. In at least one embodiment, this de-embedding head may be repurposed to implement the de-embedding model 130.

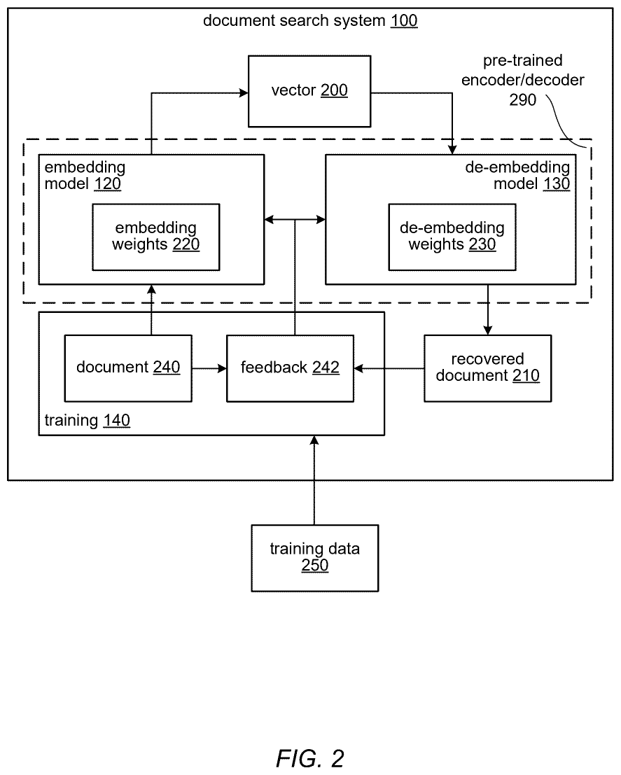

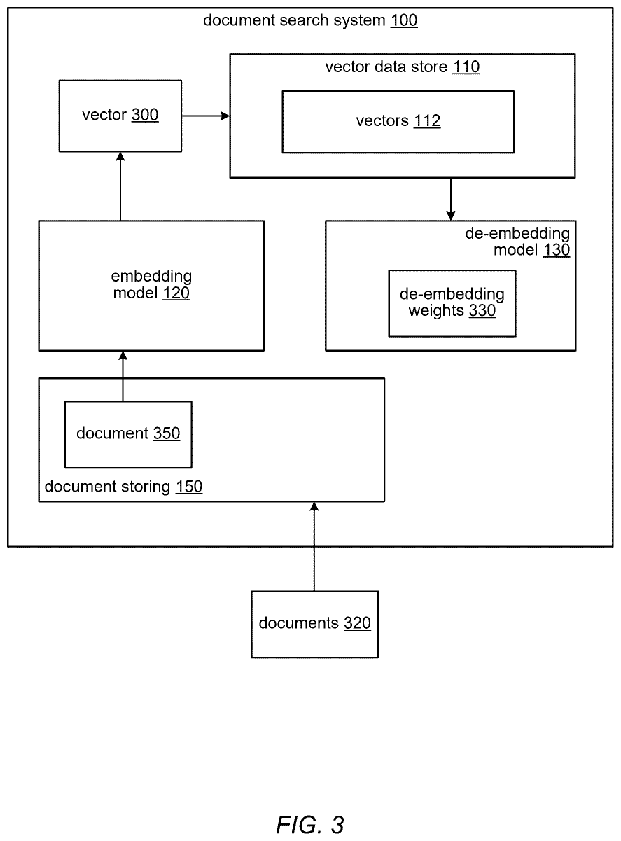

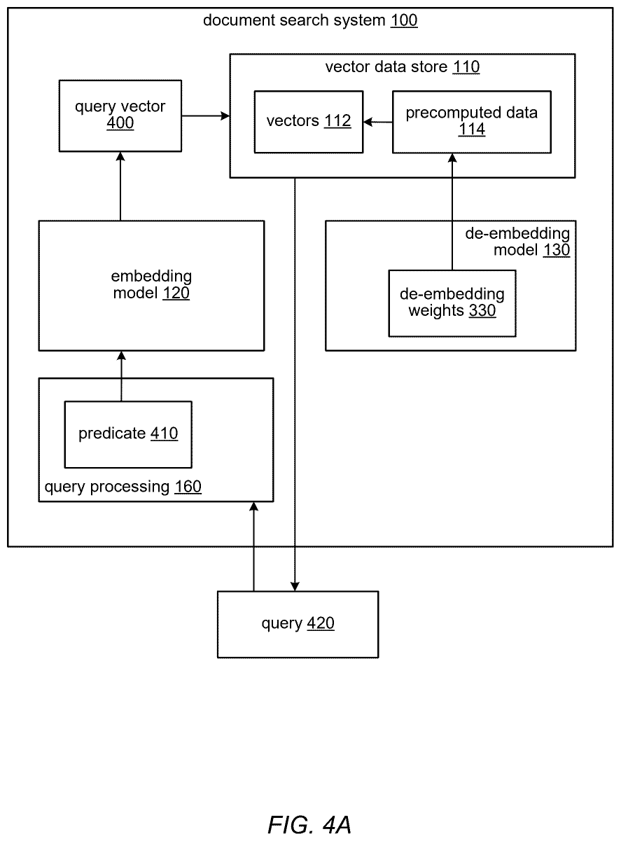

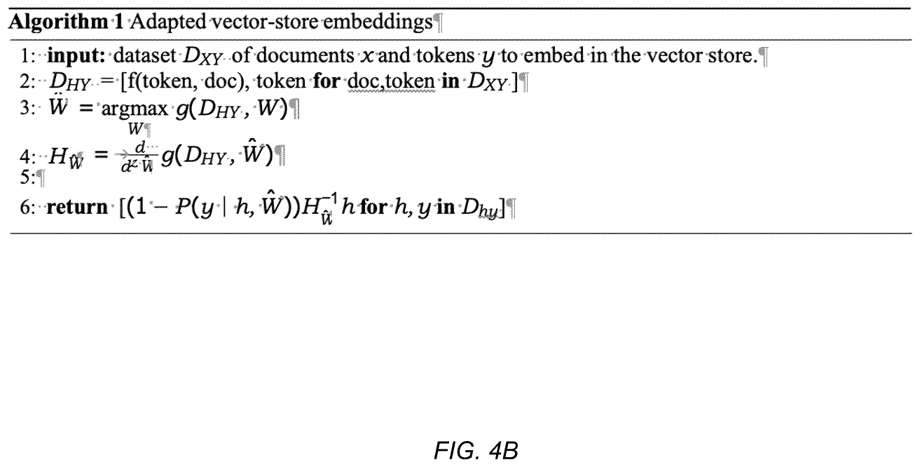

In various embodiments, document search system 100 may employ various operational phases, including a training phase 140, a document storing phase 150 and a query processing phase 160. A training phase 140 is discussed in further detail below in FIG. 2. A document storing phase 150 is discussed in further detail below in FIG. 3 and a query processing phase 160 is discussed in further detail below in FIG. 4.

FIG. 2 is a block diagram illustrating a system for training an embedding model, according to at least one embodiment. In at least one embodiment, document search system 100 may employ an embedding model 120 that may include, for training, a de-embedding head that is shown as a separate de-embedding model 130. In at least one embodiment, embedding model 120 may be trained to produce embedding weights 220, with the training process using the de-embedding head as part of a feedback mechanism for training, the training process also producing de-embedding weights 230 for the de-embedding head.

In at least one embodiment, to train the embedding and de-embedding models, training data 250 may be submitted. A training process 140 may divide training data 250 into separate documents 240 and send individual documents 240 to the embedding model 120 to generate embedding vectors 200, in at least one embodiment. These vectors 200 may then be forwarded to the de-embedding head 130 for recovery into a recovered document 210. In at least one embodiment, the recovered document 210 may be used by training 140, in combination with an original document 240, to generated feedback 242. Feedback 242 may then be used to train embedding weights 220 and de-embedding weights 230, using a variety of model training techniques such as recursive gradient descent. It should be understood that the above training technique is merely one example and any number of training techniques may be used. Furthermore, it should be understood that document search system 100 may employ any number of pre-trained models, such as BERT or colBERT, with or without additional training. In the event pre-trained models are used, in at least one embodiment a de-embedding head of a pre-trained embedding model 120 may be repurposed to serve as de-embedding model 130, where embedding weights 220 and de-embedding weights 230 are then pre-trained and further training 140 may be optional. Repurposing of a de-embedding head is discussed further below in FIG. 3 as part of storing vectors in a document search system, in at least one embodiment.

FIG. 3 is a block diagram illustrating storing vectors in a system that provides improved vector search using adapted embedding, according to at least one embodiment. In at least one embodiment, document search system 100 may employ an embedding model 120 and a de-embedding model 130. In at least one embodiment, de-embedding model 130 may be implemented using a de-embedding head of embedding model 120. As part of a document storing process or phase 150, a de-embedding model 130, either separate or repurposed from embedding model 120 and trained using the same training data as embedding model 130, may be further trained on stored vectors 112 to further train de-embedding weights 330.

In at least one embodiment, to store documents, documents 320 may be submitted to document storing phase 150. Document storing phase 150 may divide documents 320 into separate documents 350 and send individual documents 350 to the embedding model 120 to generate embedding vectors 300, in at least one embodiment. These vectors 300 may then be stored as vectors 112 in vector store 110 for future queries. In addition, in at least one embodiment vectors 300 may be forwarded to the de-embedding model 130 for training of the de-embedding model 130. Any number of training techniques may be envisioned, such as training techniques similar to those used for training of embedding model 120 as shown in FIG. 2. As such, various aspects of this training are not shown to improve clarity, although this process may be similar to that of FIG. 2 in various embodiments. Trained de-embedding model 130, using de-embedding trained weights 330, may then be usable to predict document terms from un-adapted embeddings. This process yields a chimeric model with the head of a vector-store and the body of a pre-training corpus—the de-embedding model 130 provides term distributions adapted to the vector-store data, while the embedding model 120 remains fit to the original pre-training data. By choosing a different definition of similarity, as discussed further below in FIG. 4 and based on probabilistic evidence, de-embedding weights 330 may be incorporated directly into the embeddings and similarities themselves. This allows adapting the embeddings to the data in vector data store 110 without labeled data. Therefore, no labeled data is needed to adapt the embedder to the data in the vector data store 110 as self-supervision is used instead and the technique limits catastrophic forgetting by keeping the embedding weights intact. This enables use of fine-tuned embedding models such as BERT and ColBERT, in various embodiments.

FIG. 4A is a block diagram illustrating querying vectors in a system that provides improved vector search using adapted embedding, according to at least one embodiment. In at least one embodiment, document search system 100 may employ an embedding model 120 and a de-embedding model 130, where the de-embedding model 130 includes de-embedding weights 330 trained according to vectors 112 of vector data store 110. In addition, in at least one embodiment precomputed data stored in vector data store 110 may be used to accelerate search queries 420.

In at least one embodiment, a query 420 may be submitted to perform a search of stored vectors 112. This query may be submitted to a query processing 160. Query processing 160 may then isolate a query predicate 410 and submit the predicate to embedding model 120 to generate one or more query vectors 400. Query vectors 400 may then be evaluated for similarity with individual ones of vectors 112 in vector data store 110 by applying a similarity function described below. This similarity function may used precomputed data 114 derived from de-embedding weights 330 of de-embedding model 130.

Given h and h′ as embedding vectors for a document term y and a query term y′, in a traditional vector store, a similarity may be defined as a function of a dot-product of y and y′ or a dot-product of their unit vectors if doing cosine similarity.

$$s i m ( y , {y}^{′} ) = {h}^{T} {h}^{′} \qquad ( 1 )$$

Note, this definition of similarity discards the de-embedding model so is unable to incorporate the self-supervised de-embedding matrix trained on the data in our vector store, as discussed above in FIG. 3. Instead, in at least one embodiment a similarity function may be defined as follows:

$$s i m ( y , {y}^{′} ) = [ {H}^{- 1} ( \hat{W} , {D}_{tr} ) ] {∇}_{W} log P ( y \vert h , \hat{W} ) ⊙ {∇}_{W} log P ( {y}^{′} \vert {h}^{′} , \hat{W} ) \qquad ( 2 )$$

This similarity may be approximated by reducing each gradient to its upper components, that is, the components of the gradient that correspond to the observed tokens de-embedding weights. This yields the following similarity function:

$$s i m ( y , {y}^{′} ) = ( 1 - P ( y \vert h , \hat{W} ) ) ( 1 - P ( {y}^{′} \vert {h}^{′} , \hat{W} ) ) [ {H}_{y}^{- 1} y ] {h}^{T} {h}^{′} \qquad ( 3 )$$

In at least one embodiment, self-supervised de-embedding (parameterized by W) appears in the similarity function in three places: in the probability of the document term, in the probability of the query term, and finally in the inverse Hessian term which is computed over the data in the vector store.

Rather than directly use cosine or dot-product similarity of term embeddings from an embedding model like BERT, in at least one embodiment a novel notion of search similarity described above naturally incorporates the entire vector store as part of its definition. In particular, search relevance may be defined as the amount of probabilistic evidence that a query provides in favor of the existence of a document in the vector store. In at least one embodiment, this similarity is may be a function of three things, the query, the document, and the entire vector store itself. Intuitively, the more evidence a query provides for a document's existence in a vector store, the more relevant that document is to the query. In this way, the client may be viewed as creating an experiment, the query, to answer the hypothesis about whether the information of interest exists in the vector store.

In at least one embodiment, the amount of evidence a query provides for the existence of a document may be formalized with Bayes factors, using the de-embedding model 130 as a model of the probability that a document term exists in the data store.

Formally, let D be the set of data points in the vector store 110. Let H1 be the hypothesis that y∈D and H2 be the hypothesis that y∈/D. Token (term) granularity may be used since this is the granularity at which embedding models 120 like BERT operate. Therefore y∈D is also a token in some document or passage (or some other relevant context) x.

Let f (y, x)→h be an embedding model, like BERT, that maps the token y and its context to an embedding vector h. Let P (y|h, W) be the de-embedding model 130 which models the probability of a token y given the embedding vector h=f (y, x) and de-embedding weights 330 W. In order for P to model the probability of the token given the data D in the vector store, we train its weights 330 W to maximize the likelihood g(W, D) of all x∈D:

$$P ( y \vert \hat{W} ) = softmax ( hT {\hat{W}}^{T} y ) where \hat{W} = arg {max}_{W} g ( D , W ) \qquad ( 4 )$$

For example, assuming BERT is employed as embedding model 120, the above would be equivalent to taking BERT, throwing away the de-embedding weights, and then re-training just the de-embedding weights from scratch on all the data in vector data store 110. This results in a BERT model in which the embedding weights still only reflect the pre-training data, but the final de-embedding weights 330 now also reflect the data in the vector store 110. In a sense, the de-embedding head is a learned adaption function between the pre-training embeddings and the data in the vector store 110.

Suppose a query 420 including query predicate 410 x′ is processed. In at least one embodiment an amount of evidence may be determined that a token y′∈x′ provides for hypothesis H1:

$${H}_{1} = y ∈ D - \to {\hat{W}}_{1} = arg {max}_{W} g ( W , D ) \qquad ( 5 )$$

$${H}_{2} = y ∉ D - \to {\hat{W}}_{2} = arg {max}_{W} g ( W , D ∖ x ) \qquad ( 6 )$$

These two competing hypotheses imply two competing models: one trained on all the data in the vector store, and the other trained on all the data in the vector store except for y.

A Bayes factor (BF) formally quantifies how much evidence the query x′ provides in support of x∈D. Let y′ be the self-supervision target for the query and h′=f (x′) be the embedding of the query:

$$B {F}_{12} = \frac{P ( {y}^{′} \vert H 1 )}{P ( {y}^{′} \vert H 2 )} \qquad ( 7 )$$

$$B {F}_{12} = \frac{P ( {y}^{′} \vert {h}^{′} , \hat{W} 1 )}{P ( {y}^{′} \vert {h}^{′} , \hat{W} 2 )} \qquad ( 8 )$$

Computing this for every data point is not practical since it requires training a separate model for every point in the data store, which could be expensive.

Instead, we can use infinitesimal jackknife (influence functions) to get an approximation of the log of this ratio by using it to approximate the denominator and plug it in to the log ratio.

$$log B {F}_{12} \approx [ {H}^{- 1} ( \hat{W} , {D}_{tr} ) ] {∇}_{W} log P ( y \vert h , \hat{W} ) ⊙ {∇}_{W} log P ( {y}^{′} \vert {h}^{′} , \hat{W} ) \approx [ {H}_{y}^{- 1} ] ( 1 - P ( y \vert h , \hat{W} ) ) {h}^{T} ( 1 - P ( {y}^{′} \vert {h}^{′} , \hat{W} ) ) {h}^{′} = ( 1 - P ( y \vert h , \hat{W} ) ) ( 1 - P ( {y}^{′} \vert {h}^{′} , \hat{W} ) ) [ {H}_{y}^{- 1} ] {h}^{T} {h}^{′} \qquad ( 9 )$$

Where Ŵ=Ŵ₁ are the token prediction head weights when trained on the entire vector store including point x and

$${H}_{y}^{- 1}$$

are the components of the inverse Hessian corresponding only to y. Note in the second step, gradients are reduced down to only the components that correspond to the observed weights. This results in an approximation, but the benefit is that we only vectors need to be stored rather than full gradient matrices in the vector store. This approximation yields Equation 3 provided above.

This similarity equation involves the computation and inversion of the Hessian matrix which naively would be the number of parameters in the de-embedding head squared. However, a block-diagonal or even a diagonal approximation may be used in at least one embodiment, and it should be understood that this matrix may be calculated and inverted just one time. Cost may therefore be amortized over the life-time of the vector store. The Hessian-vector products may be pre-computed and stored in the vector-store as embeddings. This allows the similarity algorithm to be merely a dot-product and a scalar operation such that searches will be the same speed as with traditional approaches. We show how to compute the adapted embeddings with self-supervision in Algorithm 1 as shown in FIG. 4B. That is, the similarity function then only needs to compute (1−P(y′|h′, Ŵ))(h_{adapted})^{T}h′ where h_{adapted} is pre-computed by the algorithm.

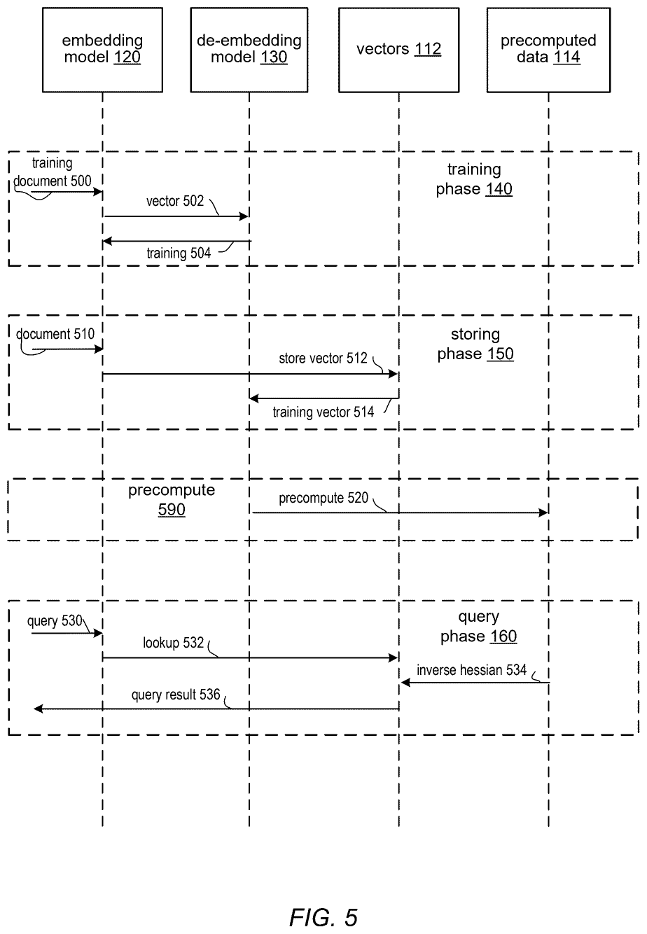

FIG. 5 is a timing diagram of a system for providing improved vector search using adapted embedding, according to at least one embodiment. A document search system, such as the document search system 100 of FIG. 1, may first pretrain and embedding model 120 and de-embedding model 130, in various embodiments. In at least one embodiment, a pre-trained embedding model 120 and de-embedding model 130, such as BERT or colBERT, may be used, obviating the need for pre-training. In at least one embodiment, embedding model 120 may be trained to produce embedding weights such as embedding weights 220 of FIG. 2, with the training process using a de-embedding head as part of a feedback mechanism for training, the training process also producing de-embedding weights such as de-embedding weights 230 of FIG. 2 for the de-embedding head.

In at least one embodiment, using a training phase 140 training documents 500 may be individually submitted to an embedding model 120 to generate embedding vectors 502 that are subsequently forwarded to the de-embedding head 130 for recovery into a recovered document such as recovered document 210 as shown in FIG. 2. In at least one embodiment, the recovered document may be used for training 504, in combination with an original document, to generated feedback such as feedback 242 of FIG. 2. Feedback may then be used to train embedding weights and de-embedding weights, using a variety of model training techniques such as recursive gradient descent. It should be understood that the above training technique is merely one example and any number of training techniques may be used. Furthermore, it should be understood that document search system 100 may employ any number of pre-trained models, such as BERT or colBERT, with or without additional training.

A document search system, such as the document search system 100 of FIG. 1, may then implement a storing phase 150 storing vectors for subsequent search, in various embodiments. As part of a document storing phase 150, a de-embedding model 130, either separate or repurposed from embedding model 120 and trained using the same training data as embedding model 130, may be further trained on stored vectors to further train de-embedding weights. In at least one embodiment, to store documents, documents such as documents 320 of FIG. 3, may be individually submitted to embedding model 120, as shown in 510, to generate embedding vectors, such as vectors 300 of FIG. 3. Document storing phase 150 may divide documents into separate documents and send individual documents to the embedding model 120 to generate embedding vectors, in at least one embodiment. These vectors may then be stored 512 as vectors 112 in vector store such as vector store 110 of FIG. 3 for future queries. In addition, in at least one embodiment vectors may be forwarded to the de-embedding model 130 for training 514 of the de-embedding model 130. Any number of training techniques may be envisioned, such as training techniques similar to those used for training of embedding model 120 as shown in FIG. 2.

Trained de-embedding model 130 may then be usable to predict document terms from un-adapted embeddings. This process yields a chimeric model with the head of a vector-store and the body of a pre-training corpus—the de-embedding model 130 provides term distributions adapted to the vector-store data, while the embedding model 120 remains fit to the original pre-training data. By choosing a different definition of similarity, as discussed above in FIG. 4A and based on probabilistic evidence, de-embedding weights may be incorporated directly into the embeddings and similarities themselves. This allows adapting the embeddings to the data in a vector data store without labeled data. Therefore, no labeled data is needed to adapt the embedder to the data in a vector data store as self-supervision is used and the technique limits catastrophic forgetting by keeping the embedding weights intact. This enables use of fine-tuned embedding models such as BERT and ColBERT, in various embodiments.

A document search system, such as the document search system 100 of FIG. 1, may precompute data, such as precomputed data 114 of FIG. 4A by accessing weights of de-embedding model 130 and storing computation such as described above in FIG. 4A as precomputed data 114 in a vector store along side vectors 112, in at least one embodiment. It should be understood that this precomputing of data could be performed at various stages. For example, precomputing 520 could be performed incrementally during storing phase 150 in at least one embodiment, and in another embodiment precomputing 520 may be performed once after completion of storing of vectors, with precomputed data 114 updated as needed due to additional vectors being stored. In at least one embodiment, precomputed data 114 may be generated on demand during a query phase 160 upon determination that embedding weights of de-embedding model 130 may have changed due to addition storing of vectors. It should be understood that these are merely examples and any number of precomputing techniques may be envisioned.

A document search system, such as the document search system 100 of FIG. 1, may then implement a query phase 160. A query to perform a search of vectors 112 may be received at a query phase 160. Query phase 160 may then isolate a query predicate, such as query predicate 410 of FIG. 4, and submit 530 the predicate to embedding model 120 to generate one or more query vectors, such as query vectors 400 of FIG. 4. Q These query vectors may then be evaluated for similarity with individual ones of vectors 112 by applying a similarity function in a lookup operation 532. This process is described in further detail above in FIG. 4A. The similarity function may access precomputed data 114, such as an inverse hessian matrix 534, derived from de-embedding weights of de-embedding model 130. Query phase 160 may then provide a query result 536 that includes at least one vector of vectors 112 identified based at least in part on a similarity to the query vectors generated from the query predicate.

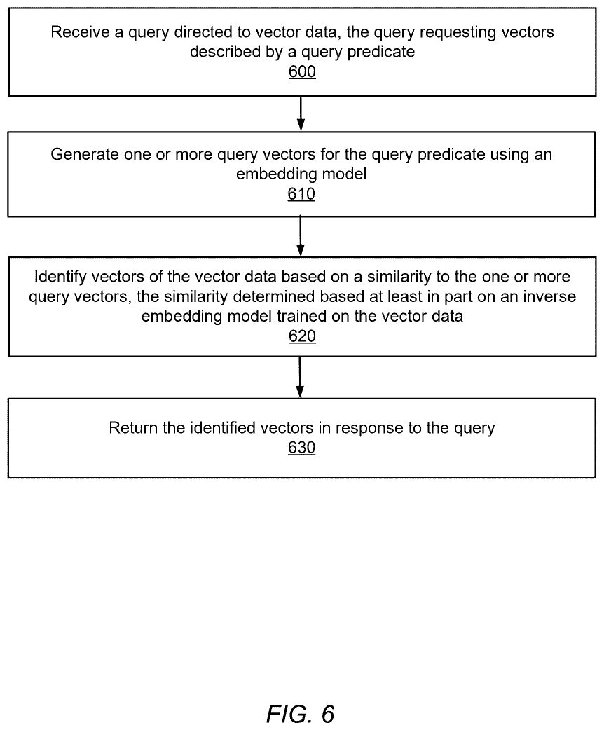

FIG. 6 is a flow diagram illustrating querying vectors in a system that provides improved vector search using adapted embedding, according to at least one embodiment. The process begins at 600 where, in at least one embodiment, a query may be received that is directed to vector data, the query requesting vectors that match a description provided in a query predicate.

Then, as shown in 610, in at least one embodiment one or more query vectors may be generated from the query predicate using and embedding model, such as embedding model 120 of FIG. 1. The query predicate may, in at least one embodiment, include a description in a textual format and a pretrained model such as BERT or colBERT may be used for the embedding model, in various embodiments.

Then, as shown in 620, in at least one embodiment vectors in a vector data store may be identified based on a similarity to the generated query vectors, the similarity determined based at least on part on an inverse embedding model trained on vector data of the vector data store. The similarity may be determined based on a similarity function as described about in FIG. 4A, in at least one embodiment.

Then, as shown in 630, in at least one embodiment the identified vectors may be returned responsive to the query.

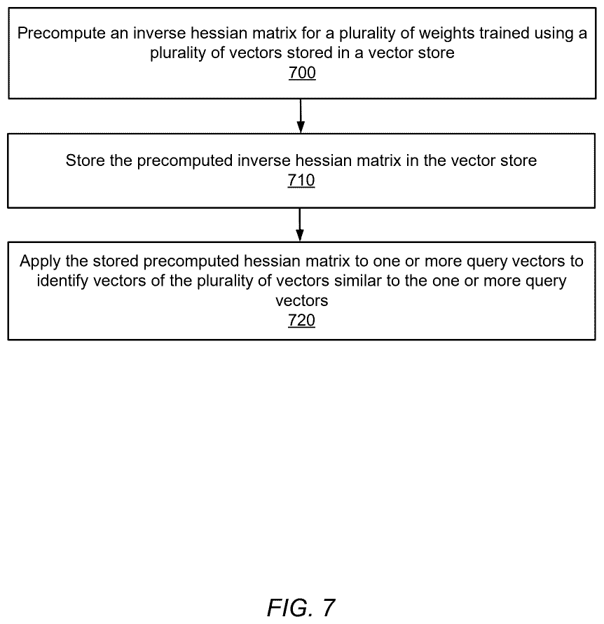

FIG. 7 is a flow diagram illustrating precomputing search data for querying vectors in a system that provides improved vector search using adapted embedding, according to at least one embodiment. As shown in 700, in at least one embodiment an inverse hessian matrix may be precomputed for implementation of a similarity function. This matrix may be computed for a plurality of de-embedding weights trained using a plurality of vectors stored in a vector store, such as the vector data store 11 of FIG. 1. The similarity function involves the computation and inversion of the Hessian matrix which naively would be the number of parameters in the de-embedding head squared. However, a block-diagonal or even a diagonal approximation may be used in at least one embodiment, and it should be understood that this matrix may be calculated and inverted just one time. Precomputation allows the similarity function to be merely a dot-product and a scalar operation such that searches will be the same speed as with traditional similarity functions. Details of the inverse hessian computation are shown in Algorithm 1 of FIG. 4B above.

As shown in 710, in at least one embodiment the precomputed inverse hessian matrix may then be stored in the vector data store along side searchable vector embeddings, such as vectors 112 of FIG. 1. Then, as shown in 720, in at least one embodiment the stored precomputed inverse hessian matrix may be retrieved and applied to one or more query vectors to identify stored vectors that are similar to a search query as defined by a query predicate. This process is described in further detail above in FIG. 4A.

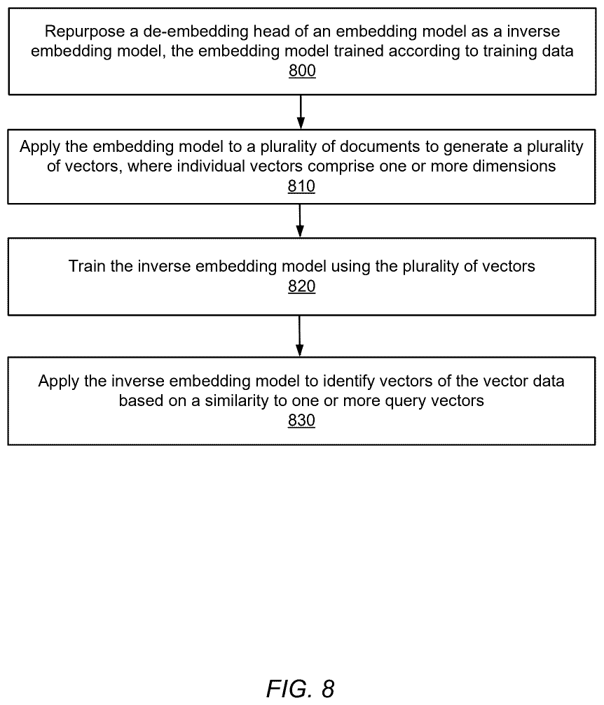

FIG. 8 is a flow diagram illustrating training an inverse embedding model in a system that provides improved vector search using adapted embedding, according to at least one embodiment. As shown in 800, in at least one embodiment a de-embedding head of an embedding model, such as embedding model 120 of FIG. 1, may be repurposed as an inverse embedding model, such as de-embedding model 130 of FIG. 1, where the de-embedding head has been previously trained according to training data, such as training data 250 of FIG. 2.

As shown in 810, in at least one embodiment a document search system, such as the document search system 100 of FIG. 1, may further train an inverse embedding model by applying an embedding model on data to generate a plurality of stored vectors and further train de-embedding weights, such as the de-embedding weights 330 of FIG. 3, using the stored vectors. These vectors may include one or more dimensions, in various embodiments. In at least one embodiment, to store documents, documents such as documents 320 of FIG. 3, may be individually submitted to an embedding model, such as embedding model 120 of FIG. 1, to generate embedding vectors, such as vectors 300 of FIG. 3. These vectors may then be stored as vectors such as vectors 112 of FIG. 1 in vector store such as vector store 110 of FIG. 3 for future queries. In addition, in at least one embodiment vectors may be forwarded to the de-embedding model for training of the de-embedding model. Any number of training techniques may be envisioned, such as training techniques similar to those used for training of embedding model 120 as shown in FIG. 2, in various embodiments.

As shown in 820, in at least one embodiment the inverse embedding model may then be trained on the plurality of stored vectors. Then, as shown in 830, the inverse embedding model may be applied to identify stored vectors based on a similarity to one or more query vectors generated according to a query predicate. This apply process is discussed in further detail above in FIG. 4A and FIG. 7.

Some of the mechanisms described herein may be provided as a computer program product, or software, that may include a non-transitory, computer-readable storage medium having stored thereon instructions which may be used to program a computer system 2000 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

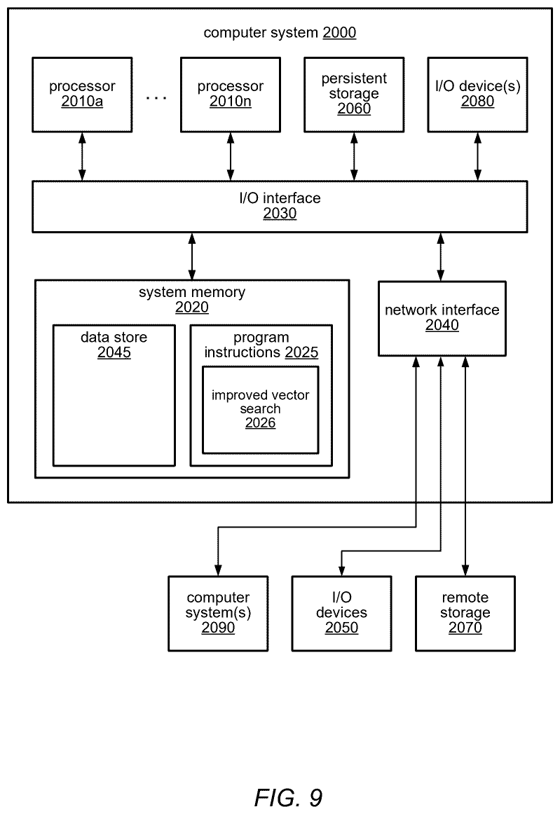

Any of various computer systems may be configured to implement processes associated with a technique for multi-region, multi-primary data store replication as discussed with regard to the various figures above. FIG. 9 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 9 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for improved vector search as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 9 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A computer-implemented method, comprising:
training an inverse embedding model according to a plurality of vectors generated according to an embedding model and respective input data, the plurality of vectors individually comprising one or more dimensions; and
identifying at least one vector of the plurality of vectors based at least in part on a similarity to at least one query vector generated from a query predicate according to the embedding model, wherein the similarity is determined according to a similarity function based at least in part on the inverse embedding model.

2. The computer-implemented method of claim 1, further comprising storing the plurality of vectors at a vector store, wherein the query predicate is part of a search performed at the vector store.

3. The computer-implemented method of claim 1, wherein the embedding model comprises a plurality of weights determined according to training data to generate one or more output vectors according to one or more categorical input data, and wherein the inverse embedding model comprises another plurality of weights determined according to the plurality of vectors and the training data to generate one or more categorical output data according to one or more input vectors.

4. The computer-implemented method of claim 1, wherein the input data is textual data, and wherein the embedding model is a large language model.

5. The computer-implemented method of claim 1, wherein the similarity function comprises a Bayesian model of a probability that the at least one query vector matches the at least one vector of the plurality of vectors.

6. The computer-implemented method of claim 1, wherein the similarity function comprises an inverse Hessian matrix.

7. The computer-implemented method of claim 6, further comprising:
precomputing the inverse Hessian matrix according to the plurality of vectors; and
storing the precomputed inverse Hessian matrix and the plurality of vectors at a vector store.

8. One or more non-transitory computer-accessible storage media storing program instructions that when executed on or across one or more processors cause the one or more processors to perform:
training an inverse embedding model according to a plurality of vectors generated according to an embedding model and respective input data, the plurality of vectors individually comprising one or more dimensions; and
identifying at least one vector of the plurality of vectors based at least in part on a similarity to at least one query vector generated from a query predicate according to the embedding model, wherein the similarity is determined according to a similarity function based at least in part on the inverse embedding model.

9. The one or more non-transitory computer-accessible storage media of claim 8, wherein the instructions that when executed on or across one or more processors cause the one or more processors to further perform storing the plurality of vectors at a vector store, wherein the query predicate is part of a search performed at the vector store.

10. The one or more non-transitory computer-accessible storage media of claim 8, wherein the embedding model comprises a plurality of weights determined according to training data to generate one or more output vectors according to one or more categorical input data, and wherein the inverse embedding model comprises another plurality of weights determined according to the plurality of vectors and the training data to generate one or more categorical output data according to one or more input vectors.

11. The one or more non-transitory computer-accessible storage media of claim 8, wherein the input data is textual data, and wherein the embedding model is a large language model.

12. The one or more non-transitory computer-accessible storage media of claim 8, wherein the similarity function comprises a Bayesian model of a probability that the at least one query vector matches the at least one vector of the plurality of vectors.

13. The one or more non-transitory computer-accessible storage media of claim 8, wherein the similarity function comprises an inverse Hessian matrix.

14. The one or more non-transitory computer-accessible storage media of claim 8, wherein the instructions that when executed on or across one or more processors cause the one or more processors to further perform:
precomputing the inverse Hessian matrix according to the plurality of vectors; and
storing the precomputed inverse Hessian matrix and the plurality of vectors at a vector store.

15. A system, comprising:
a vector store comprising at least one processor and a memory, configured to:
store a plurality of vectors generated according to an embedding model and respective input data, the plurality of vectors individually comprising one or more dimensions;
train an inverse embedding model according to the plurality of and the respective input data; and
identify, responsive to a query received at the vector store, at least one vector of the plurality of vectors based at least in part on a similarity to at least one query vector generated from a predicate of the query according to the embedding model, wherein the similarity is determined according to a similarity function based at least in part on the inverse embedding model.

16. The system of claim 15, wherein the embedding model comprises a plurality of weights determined according to training data to generate one or more output vectors according to one or more categorical input data, and wherein the inverse embedding model comprises another plurality of weights determined according to the plurality of vectors and the training data to generate one or more categorical output data according to one or more input vectors.

17. The system of claim 15, wherein the input data is textual data, and wherein the embedding model is a large language model.

18. The system of claim 15, wherein the similarity function comprises a Bayesian model of a probability that the at least one query vector matches the at least one vector of the plurality of vectors.

19. The system of claim 15, wherein the similarity function comprises an inverse Hessian matrix.

20. The system of claim 15, the vector store further configured to:
precompute the inverse Hessian matrix according to the plurality of vectors; and
store the precomputed inverse Hessian matrix.
